(19) United States
(12) Patent Application Publication
(10) Pub. No.: US 2014/0164249 A1
(43) Pub. Date: Jun. 12, 2014

(54) METHOD AND SYSTEM FOR SECURE AUTHENTICATION AND INFORMATION SHARING AND ANALYSIS

(71) Applicant: FINANCIAL SERVICES/INFORMATION SHARING & ANALYSIS CENTER, Reston, VA (US)

(72) Inventors: Eric GUERRINO, Howell, NJ (US); William NELSON, Leesburg, VA (US)

(73) Assignee: FINANCIAL SERVICES/INFORMATION SHARING & ANALYSIS CENTER, Reston, VA (US)

(21) Appl. No.: 13/950,817

(22) Filed: Jul. 25, 2013

Related U.S. Application Data
(60) Provisional application No. 61/675,610, filed on Jul. 25, 2012.
(60) Provisional application No. 61/675,939, filed on Jul. 26, 2012.

(51) Int. Cl. G06Q 20/38

(52) U.S. Cl. CPC G06Q 20/3821
USPC 705/64

(57) ABSTRACT

A method for selectively permitting access over a computer network to two or more sets of information that have been assigned different confidentiality levels in which access to information having a lower level of confidentiality requires an authentication process requiring only a UserID and a password, and in which access to information having a higher level of confidentiality requires an authentication process requiring a UserID, a password, and a hard token, but no additional PIN.

### CROSS-REFERENCE TO RELATED APPLICATIONS

This application is a non-provisional of U.S. provisional patent application Ser. No. 61/675,610 entitled METHOD AND SYSTEM FOR SECURE AUTHENTICATION AND INFORMATION SHARING AND ANALYSIS filed on Jul. 25, 2012, and of U.S. provisional patent application Ser. No. 61/675,939 entitled METHOD AND SYSTEM FOR SECURE AUTHENTICATION AND INFORMATION SHARING AND ANALYSIS filed on Jul. 26, 2012, both which are incorporated herein by reference in their entirety.

### BACKGROUND OF THE INVENTION

1. Field of the Invention

This invention relates to the portal and website information member authentication sharing, and analysis services. Authentication processes represent a key control for member's access to levels of information based on the risk classification of the information.

2. Background

Applicant, Financial Services Information Sharing and Analysis Center (FS-ISAC), is a nonprofit private sector initiative that was designed and developed by Banks, Insurance Companies, Payment Processors, and Brokerage Firms. The goal of the FS-ISAC is to share timely, relevant and actionable information and analysis of physical and cyber security information to its members. The FS-ISAC portal and website offers members one place to go for trusted information sharing with financial services firms that includes threat data, vulnerability information, leading practices in IT risk management, emerging practices in physical security management, business resiliency approaches and practices; direct access to the best minds in the industry related to business resiliency, IT risk, security—a unique combination of knowledge, information, resources and analysis.

Members use the Portal and website for access to essential information including Relevant/actionable cyber & physical alerts, iDEFENSE briefings/whitepapers, Member contact directory, Risk Mitigation Toolkit, Document Repository, Member anonymous submissions, Threat Intelligence listserv, Member surveys, Viewpoints, Government and cross-sector information sharing, and Government provided information.

In 2003, the Banking and Finance Sector, hereinafter referred to as the Financial Services Sector, was identified as a critical infrastructure sector pursuant to Homeland Security Presidential Directive 7 (HSPD-7); the U.S. Department of the Treasury was identified as the Sector-Specific Agency (SSA) for the sector. As the SSA, the Treasury Department works with its public and private sector partners to maintain a robust sector that is resilient against manmade or natural incidents. The Financial Services Sector is essential to the efficiency of world economic activity.

Both the private and public sectors, through the Financial Services Sector Coordinating Council for Critical Infrastructure Protection and Homeland Security (FSSCC) and the Financial and Banking Information Infrastructure Committee (FBIIC), respectively, have key roles in defining and implementing the Financial Services Sector's critical infrastructure and key resources (CIKR) protective programs. Through direct mandates and regulatory authority, Federal and State financial regulators have specific regulatory tools that they can implement in response to a crisis that affects the sector's business functions. In addition, the Department of the Treasury—along with the FBIIC, the FSSCC, Financial Services Information Sharing and Analysis Center (FS-ISAC), and regional partnerships—have developed and continue to implement numerous protective, detective and responsive programs to meet the Financial Services Sector's goals. The protective programs range from developing and testing robust emergency communication protocols, to identifying critical Financial Services Sector threats, to addressing cyber security threats and risk mitigation strategies. The success of the public-private partnership has proven critical to the Financial Services Sector's achievements through one of the most challenging periods for the sector with respect to credit and liquidity risks.

The scope of the Financial Services Sector includes public and private institutions involved in carrying out the primary sector functions of depositing funds, making payments, providing credit and liquidity, investing, and transferring financial risk. Multiple organizations perform these functions and collectively represent the Financial Services Sector including Clearinghouses, Commercial banks, Credit rating agencies, Exchanges/electronic communication networks, Financial advisory services, Insurance companies, Financial utilities Government and industry regulators, Government subsidized entities, Investment banks, Merchants, Retail banks, and Electronic payment firms.

The Financial Services Sector's three sector goals are to achieve the best possible position in the face of myriad intentional, unintentional, manmade, and natural threats against the sector's physical and cyber infrastructure; to address and manage the risks posed by the dependence of the sector on the Communications, Information Technology, Energy, and Transportation Systems Sectors; and to work with the law enforcement and intelligence communities, financial regulatory authorities, the private sector, and our international counterparts to address threats facing the Financial Services Sector.

The FSSCC and FS-ISAC work together on preparation of specific threat products for the sector including developing of a Whitepaper on risk mitigation of Advanced Persistent Threat (APT). The FS-ISAC members share information on a daily basis to better prepare the operators of critical financial services infrastructure to address the risks of business disruption and resiliency that could potentially damage or disrupt financial markets and/or cause significant risk to customers of financial institutions. The information is shared with other members

### SUMMARY OF THE INVENTION

Currently, the FS-ISAC member portal supports both single factor authentication (username/password) and multi-factor authentication (RSA SecurID hard tokens). Users are assigned either a username/password, or a username/SecurID token, based on the membership level of their member institution. In addition, the GISF and CSISF programs require the use of multi-factor authentication, so participants in those programs are assigned SecurID tokens.

Members log into the FS-ISAC Member Portal by selecting the “Member Login” button on the home page, and selecting their membership level, see, e.g., FIG. 5. This opens one of two login pages, based on the user's membership type; either a login page prompting the user for a username and password, or an RSA SecurID login page.

Alternatively, users can access a specific record in the portal by following the “deep link” in an email alert for that record. The “deep link” is customized by the portal based on each recipient's membership level, so that the link takes the user to the correct login page for their membership level (username/password, or RSA SecurID), then redirects the user to the specific record within the portal.

The following table shows the authentication mechanisms employed on the FS-ISAC member portal:

| Membership | Authentication |
|---|---|
| Type | Type |
| CNOP | None (email only) |
| Basic | Username/Password |
| Core | Username/Password |
| Affiliate | Username/Password |
| Limited Observer | Username/Password |
| Standard | SecurID Token |
| Premier | SecurID Token |
| Gold | SecurID Token |
| Platinum | SecurID Token |
| CSISF | SecurID Token |
| GISF | SecurID Token |

Due to the way UAG and SharePoint handle user authentication and session management there is no easy way for UAG to properly identify who the user is based on their SecurID authentication. Custom code can be written to extract the Username from the SecurID cookie and programmatically identify them to SharePoint, but this solution is not compatible with existing Adaptive Authentication integration code.

According to the present invention the authentication model would require users to enter their password along with their SecurID tokencode when they log in with their SecurID token. There would be no change to the user authentication process when a user logs in with their username/password.

To prevent this from significantly impacting the user experience, one embodiment of the invention eliminates the PIN requirement for SecurID tokens. In essence, the user's password would take the place of their SecurID PIN when they authenticate with their token. This feature of the invention would allow UAG and SharePoint to use the Username/password combination to identify the user, and SecurID to act as an additional layer of security on top of the username/password authentication.

In short, the system will always authenticate using user name and password. The SecurID is prompted for only when a user attempts to access highly restricted or “Red” content and a separate SecurID PIN is not needed. When responding to a request for SecurID authentication, the user will enter username, password, and the token code.

All of the information on the FS-ISAC Portal and website is classified according to the protocol shown in FIG. 2.

Use Case #1: User logs Into the FS-ISAC Portal with username/password

For “typical” user logins, the user would go to the login page, and enter their username and password. See, e.g., FIG. 6. Once authenticated, the user would have access to all FS-ISAC White, Green, and Yellow content.

Use Case #2: User logs Into the FS-ISAC Portal with SecurID Token.

On the login page, the user would have an option to log in with their SecurID token, rather than username and password. See “Login with SecureID Token” option on FIG. 6. The user would be prompted to enter their Username, password, and SecurID Tokencode. See, e.g., FIG. 7. This would only be the 6-digit tokencode; no PIN. Once authenticated, the user would have access to all FS-ISAC White, Green, Yellow, and Red content that they are entitled to.

Use Case #3: User who has logged into the FS-ISAC Portal with username/password attempts to access FS-ISAC Red content, and is prompted for their SecurID tokencode.

When the user attempts to access FS-ISAC Red content, they would be prompted to authenticate with their SecurID token. See, e.g., FIG. 8. According to one embodiment of the invention, the user may be prompted to re-enter their password for enhanced security. According to another embodiment of the invention, the user is not prompted to re-enter their password.

Use Case #4: User who has already authenticated with their SecurID token attempts to access FS-ISAC Red content.

Since the user is already authenticated with their SecurID token, they are not prompted to re-authenticate, and are allowed to access the FS-ISAC Red content.

There are different membership levels that will all use the same initial authentication control.

Different membership levels have specific authorizations based on the information classification model: Premium members have access to White, Green and Yellow classified information, and Standard members have access to White and Green classified information.

Authorization requirements for the membership levels will differ based on the information classification of the portal information. Any Red classified information requires hard token authentication, any Yellow classified information requires at least 2 authentication controls or a “step-up” authentication from any lower classification, any Green classified information requires a user name and password, and any White classified information is public information and no authentication is required.

The authentication process for members will include a capability to determine the type of device being used for accessing the Portal, specifically whether a smart phone or mobile device is being used. In a case where a mobile device is being used (eg: Android, iPhone, iPad, Blackberry, Palm, tablet, smartphone, etc.) an additional challenge question or step-up authentication may be required.

According to another embodiment of the invention, additional authentication methods may be used, such as risk-based authentication (also referred to as adaptive authentication, step-up authentication, knowledge-based authentication, out of band authorization, etc.), that will increase controls with the sensitivity of the information or based on the type of device and location used for access. When specific geographical locations are used for access, the system may offer additional challenge questions to confirm the identity, particularly for determining/confirming identity in the case of a password reset transaction request.

### DESCRIPTION OF THE DRAWINGS

FIG. 1 is a flow chart showing treatment of member and analysis submissions of cyber security events.

FIG. 2 is a chart showing security classification levels and their target audiences.

FIG. 3 is an example of information sharing on the FS-ISAC portal and website.

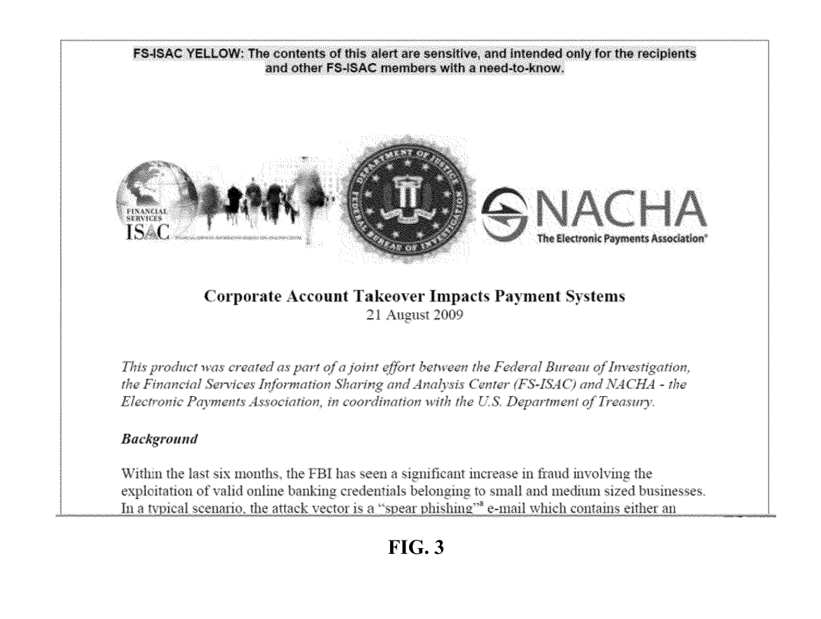

FIG. 4 is a chart showing the flow of information through FS-ISAC's Security Operations Center.

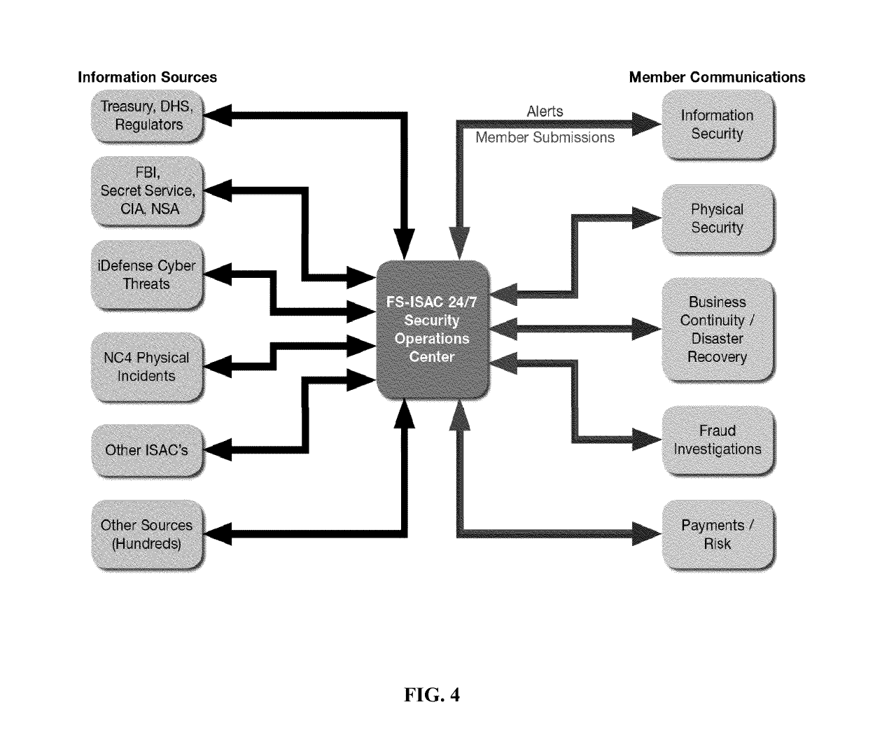

FIG. 5 is an embodiment of the member home page.

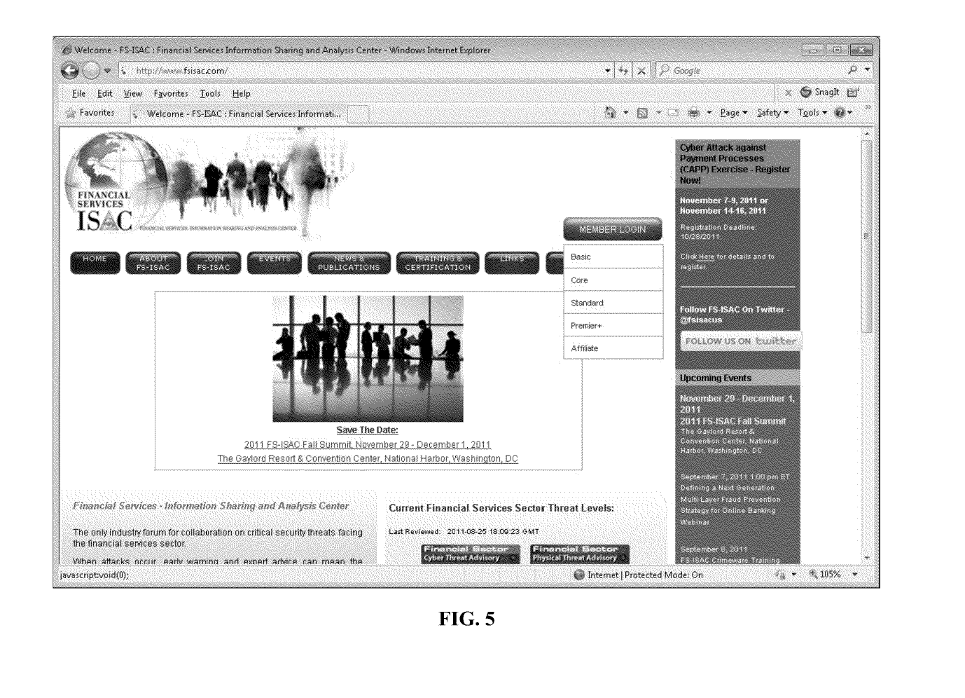

FIG. 6A is a first embodiment of a log-in screen.

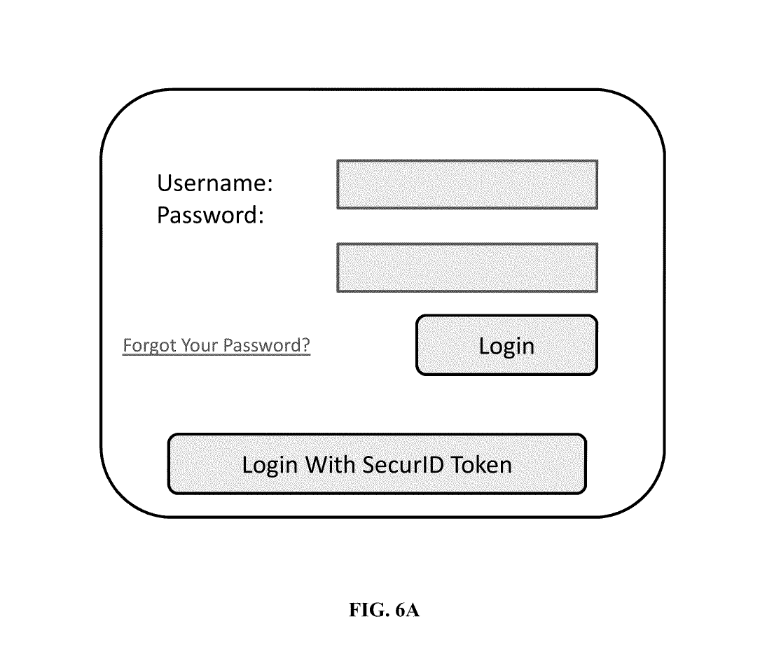

FIG. 6B is a second embodiment of a log-in screen.

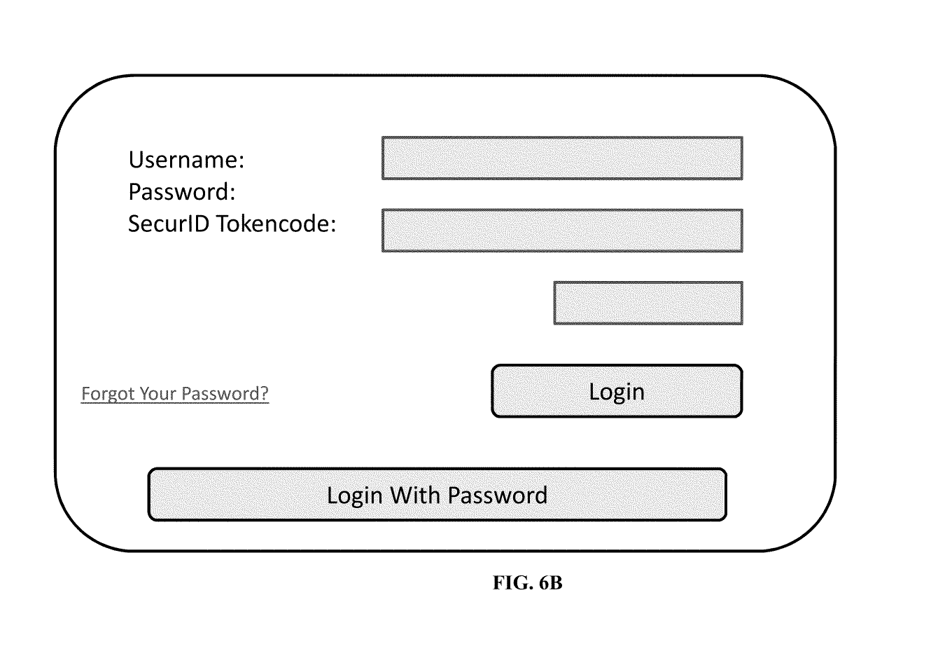

FIG. 6C is a third embodiment of a log-in screen.

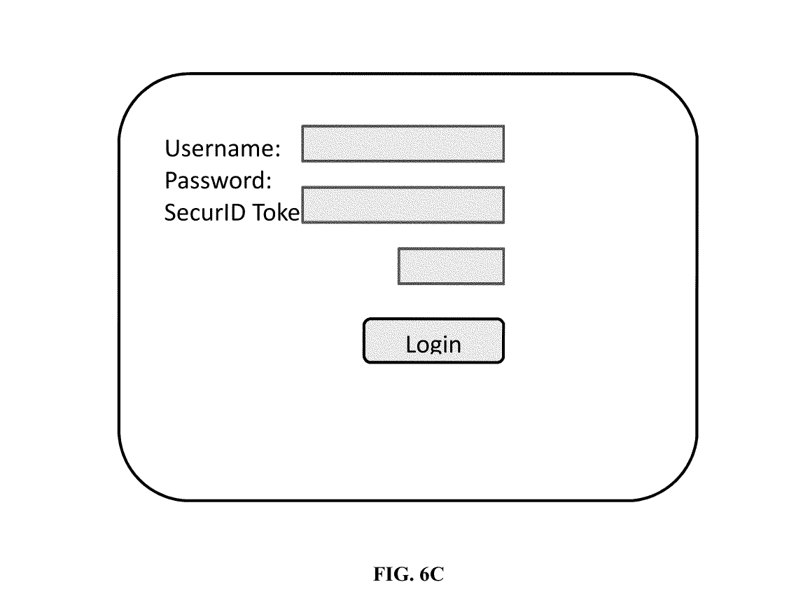

FIG. 7 is a flow chart of the risk assessment mechanism.

FIG. 8 is a flow chart of an embodiment of member submission process.

### DETAILED DESCRIPTION OF THE INVENTION

Security Architecture

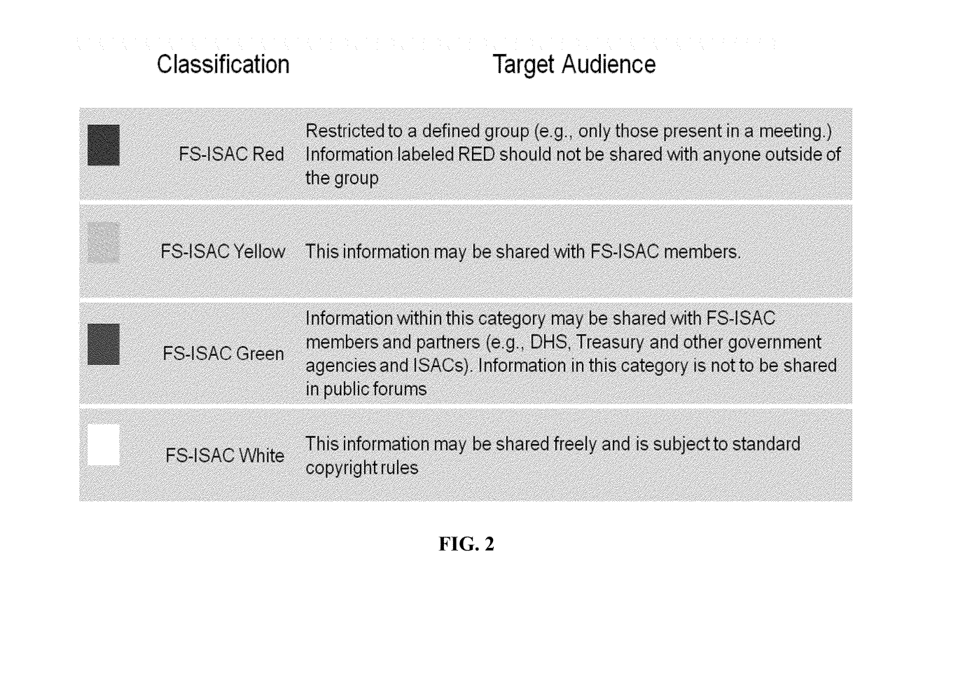

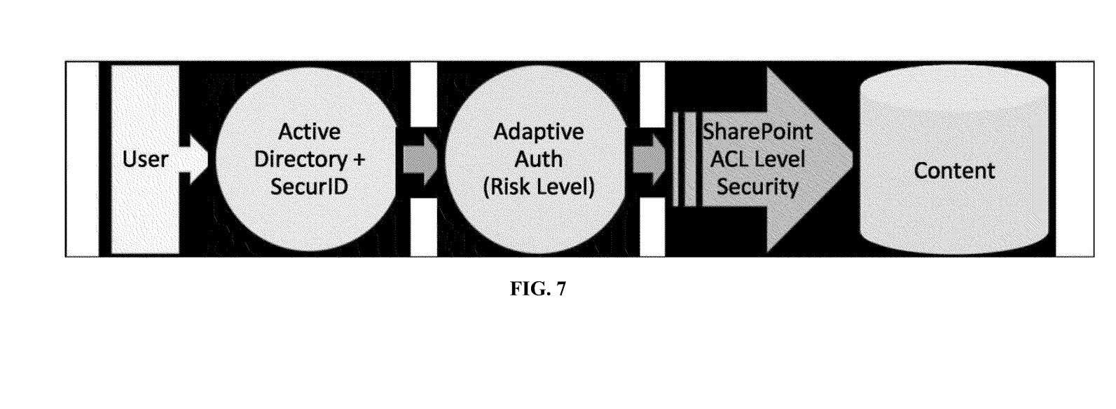

FS-ISAC information is flagged using a traffic light protocol (TLP) that includes white, green, yellow, and red. See FIG. 2. These security levels are configured in SharePoint using its native site/list/item inherited security model. The system utilizes UAG server with two types of authentication plus a risk assessment mechanism in the form of RSA adaptive authentication to prevent unauthorized access to content. The data transport over the network is encrypted using SSL. FIG. 7 shows a path through which a user may pass to gain access to the content of the site.

Authentication

The system Active Directory (AD) as an authoritative authentication store with SecurlD adding additional protection that is optional when accessing everything except for Red level content. All users will have a username and password for Active Directory as well as an RSA Token/SecurlD. The system will be setup to synchronize user accounts from Active Directory into RSA Authentication Manager. This synchronization will ensure that user consistency is automatically maintained between the two authentication sources. For example, users that are disabled in Active Directory are also disabled in RSA Authentication Manager. As part of its native functionality, the UAG login page will optionally give the user the ability to enter their SecurID if they choose. Red level content will require that the user has logged in with their SecurID, which will be enforced as a policy with UAG.

Use Case #1—A user logs into the site with their AD credentials without entering their SecurID and is able to freely browse all content not marked as Red. The user is able to see the titles of some new Red level content on the landing page of the site. The user clicks on one of these titles, but then is redirected to a login page stating that red level content requires that the user login withe their SecurlD. Once the user has logged in using their SecurlD, they are redirected back to the original red content they were trying to access.

Use Case #2—A user opens a browser and logs into the site using a username and password plus their SecurlD credentials. This user is able to browse all content and is not prompted to re-login when they click on Red level content.

Use Case #3—A user is attending a conference. They receive a red level alert on their mobile device and click on the link in the e-mail to view its content. The user does not have their SecurlD, so they are unable to view the content.

The RSA Authentication Manager server will be setup to synchronize users between Active Directory and the RSA database. This should insure that users are created/disabled in both places however there will still need to be operational support to issue the token to the user and manage Active Directory details.

Out of the box UAG contains the logic needed for the login page along with the integration between to SharePoint, Active Directory, and RSA SecurlD. The UAG integration with RSA Adaptive Authentication is a custom configuration.

Active Directory will be configured in such a way that the FS-ISAC site users are contained within a single Organizational Unit (“OU”). UAG will be configured to only allow users within this OU to login. Any admin users and service accounts will exist in a separate service account OU and can only be used within the internal network directly connected to SharePoint (not passing through UAG publicly).

The UAG endpoint client utilities will be turned off in configuration. This will allow the users to access the site without requiring any ActiveX or Java plug-ins to be active.

SharePoint Inherited Security Model

SharePoint uses an inherited security model in which permissions flow down to the user from the site to list and finally to actual content item. It is possible to place unique security at various levels within this security chain. This inheritance is very similar to the way files inherit the security of the folders they are placed in unless given specific security. User can also be configured in security groups as follows:

Active Directory Groups—An active directory group can be granted a specific permission set in SharePoint. Any users that are added to this AD group automatically inherit the permissions assigned to the group. If user appears in multiple AD groups that are added to SharePoint, the user will inherit which ever group is more privileged if there is a conflict. The downside of AD groups is that the only way to manage the membership is through Active Directory tools and not through SharePoint

SharePoint Groups—SharePoint groups can be used in a similar fashion to AD groups except that you can declare a group owner that is able to manage the users that appear in the group. This will be helpful in team sites in which you want a set of designated users to control access to the site.

RSA Adaptive Authentication

FS-ISAC will utilize the RSA Adaptive Authentication risk assessment cloud offering to add a layer of security on top of the authentication mechanisms. This risk assessment is based on a number of factors that RSA uses to determine an overall risk score for the user. For example if the user typically accesses the site from New York during normal business hours, but a request comes from that same user which originates in Moscow during the middle of the night it would be flagged as higher risk and the user would be challenged. This risk is individualized to the users, so if the user travels to Moscow once a month the system will learn and “adapt” to this condition.

Use Case #1—A user logs into the site for the first time. After the user has successfully authenticated using their credentials Adaptive Auth asks the user to identify to themselves with a set of random questions selected from a question pool to register the user. Once the user has answered these questions they are able to login to the site.

Use Case #2—A user who previously has registered with Adaptive Auth successfully authenticates using their credentials. Adaptive Auth sees that the user is accessing the system within their normal usage pattern and from a computer that has previously be used to successfully access the site. The user's risk score is low and so the user is taken directly into the SharePoint site without any additional prompts.

Use Case #3—A user who previously has registered with Adaptive Auth successfully authenticates using their credentials but they are using a new computer they purchased while on vacation in another state. Adaptive Auth then prompts them with additional questions to validate their identity based on answers they previously provided during Adaptive Auth registration. After the user has successfully supplied answers to these questions they are taken into the site.

Customization Options

Password Reset Self Service:

Although UAG server has the ability to allow the user to change their password, there is no out of the box capability to request that your password be reset. This capability will be added as a link on the login page. Clicking on this link will ask the user to enter their e-mail address. After the user has entered their e-mail address and the system has confirmed that the e-mail address matches a valid user in Active Directory an e-mail will be sent to the user asking them to click on the embedded link to reset their password. This link will open a page in the site in which they choose a new password. Once the user has created a new password the page will update the password in Active Directory.

As part of this customization a custom database table will be created that will store the unique identify generated for the reset request. This table will capture the user information including IP address, etc. from the user requesting the reset. This table can be reviewed for security purposes in conjunction with the logging information captured in section 3.5.

Red Level Content—SecurID Enforcement

A folder within the alerts list called “Red Alerts” will be created. An event receiver on the list will be created that ensures that Red content is always contained in this folder. This folder will subsequently always show up on the URL path to any Red content. UAG will be configured with a policy that enforces SecurID login if the path contains “Red Alerts”. The only custom code needed for this solution is the event receiver that enforces that Red Level content be contained in the Red Alert folder.

Password Change & Expiration Self Service

UAG has the ability to notify users that there password is about to expire within a certain number of days of expiration. UAG also has the ability to allow the user to change their password at any time; however this functionality is only exposed on the UAG portal launch page using. To get around this limitation a “Change Password” link will be created right above “Logout” on the “Personal Actions” menu of SharePoint. Clicking on this link will open the native UAG change password page with some light branding applied. Since the user is already in an active session the user “may” have to be sent back to the login page to have them sign back in.

Security & User Logging

As with any secure system there is the need to provide an auditing mechanism that can be used to trace user authentication actions and usage of the site. The administrator of the system needs a way to trace user actions within the system and have a way to spot unusual activity within the site. The site will be able to track a user's actions at a variety of layers including authentication, content access and site usage. Since there are multiple layers such as Active Directory, RSA, IIS, SharePoint, the complete traceability will involve manually combining the different logs. From an alert perspective administrators will be able to use the built in SharePoint logs to get an understanding of what users have seen a given alert. This system will provide many more capabilities with regards to user logging/auditing then the current system. The following mechanisms will be employed directly by the system in addition to any other network firewall and security devices that may be in place:

Active Directory Auditing—Active Directory will be used as the authoritative authentication source and will be the main location at which logging will be important. Active directory logging will be enabled on the OU configured for the users of the site. This logging will essentially track all changes made to each user object in AD including passwords, group membership, and other properties. This data will be surfaced through the AD event logs which allow it to be searchable, sortable by event. Third party tools are available that do analysis on the logs.

RSA Authentication Manager—The RSA Authentication Manager server will log all activity related to the use of SecurlD tokens. The server logs successful and failed authentication attempts along with all other management events related to the token.

RS Adaptive Authentication—As mentioned elsewhere in this document, the Adaptive Authentication cloud hosted product is also providing a risk based assessment about the user's connection to the system. Audit logging will be kept to track information about access attempts and failed challenges and enrollment attempts.

IIS Logs—All users will access the site through IIS. IIS logging will be turned on and the currently used AWStats package can be used to do analysis on these logs. These logs will capture information about the browser used, country of origin etc. From a security perspective the logs would capture the incoming IP address and username, and pages accessed. Any standard IIS traffic log analytic tools can be used.

SharePoint Auditing—SharePoint has the ability to turn on “Audit Logging” at various levels within the site. These logs track access and change information from a SharePoint content perspective. For example, it would show raw audit view information about the alerts. These audit logs are compiled into an Excel Spreadsheet for further analysis based on some date range.

SharePoint Analytic & Query Logging—SharePoint has the ability to trace analytics similar to that of the IIS logs. These logs are similar to the IIS logs mentioned above, but they are specific to the SharePoint content and are designed to allow administrators to have some insight as to how the content is being accessed so that adjustments can be made to navigation, etc. The query logging capabilities of SharePoint allow the administrator to see what people are searching on and make adjustments. While these are not “Security” auditing specific type logs, they do allow you to spot unusual behavior in how the site is being accessed. These logs should be used in conjunction with the IIS logs.

Member Submissions

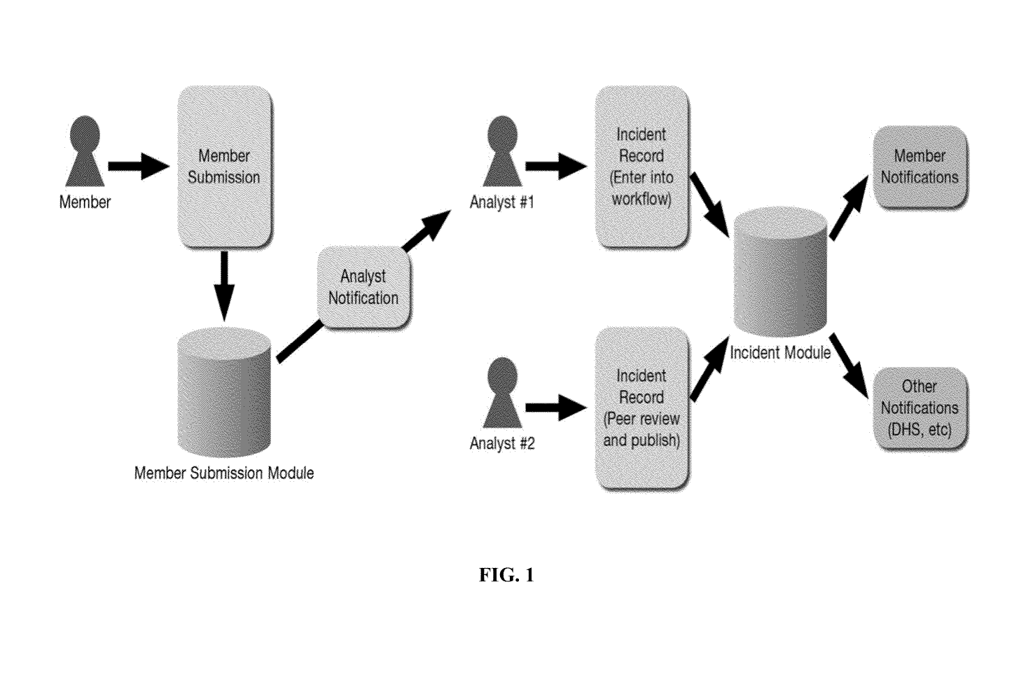

Site members need to be able to create a member submission that is then reviewed by the analysts, see FIG. 1. Users should not be able to see the submissions created by other users. These submissions may or may not be used to create new alerts depending on the research done by the analysts. An InfoPath “Smart Form” prototype was previously created to model part of the information capture experience a user would go through when creating a submission. This prototype used InfoPath form rules to adapt to the answers the user had entered. For example if the user had chosen “Malware” as the action type, the form would display questions related to malware.

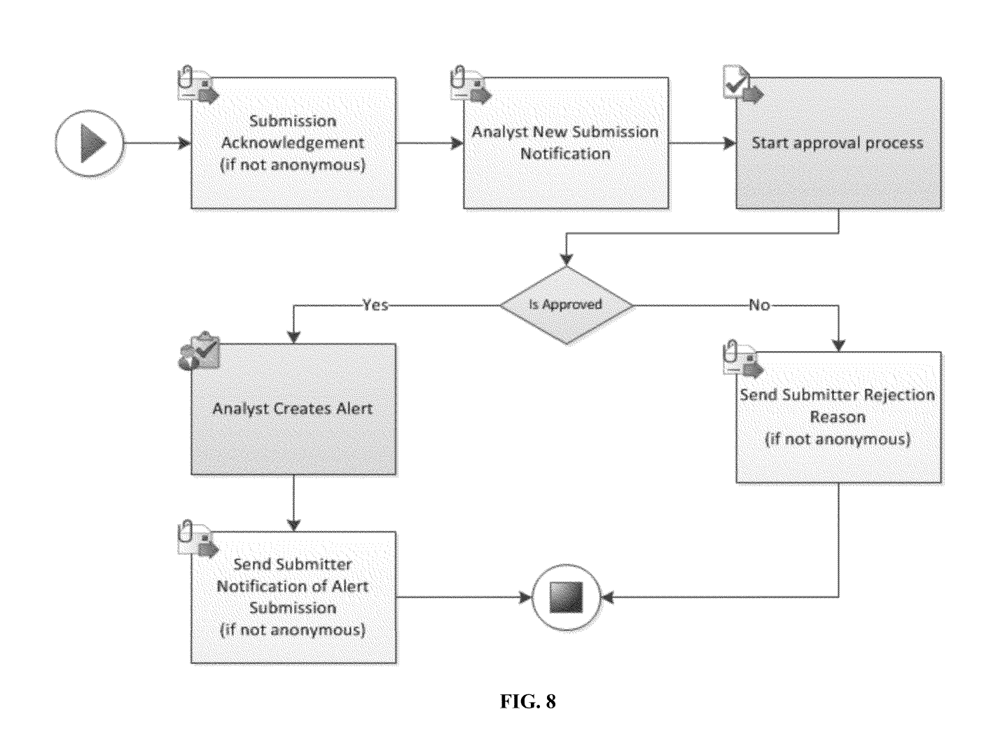

Using InfoPath to capture user submissions is a perfect use case for the technology. As part of the invention the system will be expanded to include all of the different action types and questions. Additionally one of the out of the box review workflows will be utilized to automatically start once the member has submitted. This workflow will be configured to assign a review group and members of this group will be notified that a new submission has been created. Users will not be allowed to view their submission after submittal. This is similar to how a “Contact Us” form works on many web sites. On the technical side the InfoPath “Smart Form” will be setup to submit data to a standard SharePoint List (not library) that will hold the record of the submission. It will be secured so that only administrators can see and take action on these submissions. FIG. 8 illustrates the notification point used in the workflow along with the actions of reviewing the submittal and creating an alert based on the data received.

Users will be able to mark the submission as anonymous or they can identify themselves to the system.

Custom Security Event Receiver—If users need to be able to view their previous submissions simple codes can be executed to apply specific security to each item that is submitted. This code would execute as an event receiver and would set the security to be read-only to the submitter and would grant contribute permissions to the reviewing analysts group.

Automatic Conversion To Alert—A custom workflow action may be used that would allow the analyst to copy some of the captured fields into a new alert. This process could identify the type of alert along with other key aspects.

List Based Capture—Normal SharePoint lists have a setting that lets you control the permissions so that users are only allowed to see items they created. This setting is not available on document library based lists such as an InfoPath forms library These security setting could allow some level of control over what the user is able to see.

Incoming Data Feeds

The FS-ISAC currently receives NC4 alerts as an attached XML file via a specific incoming e-mail address. Python code then pulls this XML out, reads the nodes and then creates a corresponding alert within Archer by using its APIs. The new system will be able to process NC4 alerts in a similar fashion, but will be configured to allow future XML feeds to be supported.

Using NC4 xml as an example a web service can be created to receive the incoming XML data and to place it in a SharePoint forms library called “Incoming Feeds” which is only accessible to administrators (configurable). This list will act as a log of all incoming feed data and would be sortable/searchable. InfoPath can be used to provide a UI to the feed data and can use a custom workflow action to create the actual Alert. The components needed for this to work are described below:

Custom Incoming Feed Web Service—A custom SOAP based web service will be created to support incoming data feeds XML files. The web service will be secured via username/password and the connecting party will be white listed with Adaptive Authentication. The web service will take one parameter for the incoming XML file and another to identify the type (“NC4”, “Other”). The web service will validate that the incoming XML matches the schema of the specified type. At the time of launch no external users will use the web service directly, however the same python code that processes NC4 alerts currently will also process them and add them to SharePoint.

InfoPath Form & Content Type—InfoPath has the ability to provide a UI around structured XML. An InfoPath based form will be created based on the NC4 alert structured XML. The form will be read-only, but will provide a nice way for users to view the incoming data.

Incoming XML Processing Actions—A SharePoint Workflow action can be created that will create an NC4 Alert in the normal “Alerts” list based on the data in the incoming XML. A Workflow action can be used to give some flexibility to add additional processing and notification steps as needed.

These steps require a modest amount of coding for the web service and XML processing action. The form, list and content type are all also relatively straight forward.

All incoming feed data will be XML.

All incoming XML feeds will be defined by a structured XSD document.

Data will be pushed/sent to the server and the server will not need to pull data based on a configurable schedule.

Instead of storing the incoming feed data as XML in a forms library the XML may be processed using SQL Integration Services. In this scenario the XML would be received by a web service, processed by SQL Integration Services and mapped into a table structure. It would be exposed to the users via BCS external list. This design is a good approach in the case where the incoming format is CSV, or the data includes multiple items that need some transformations before they can be imported.

Outgoing Data Feeds

The ability to pull alert information as a feed. These feeds would allow an outside consuming application the ability to securely retrieve alert information is a further embodiment of the invention. Only up to “yellow” level content would be included in the feed since “red” requires secure ID. Users would be able to use their username/password to access the feed information.

SharePoint contains basic RSS capabilities, however SharePoint also offers a “REST” based interface that allows consuming application to have more control over the information they receive by allowing them to specify filters and queries. The consuming application would also be able to specify the output format that they wish to receive for the returned results including JSON, Atom, and AtomPub. The out of the box rest API exists via a “ListData.svc” service that would create a wrapper around this service to exclude “red” content. The following are some details regarding the components:

Data Feed Service—An “AlertDataFeed.svc” will act as a wrapper around the out of the box REST API, but will exclude “red” content and will only allow access to the “Alert” list.

Restricted URL—It may be necessary to setup a data specific URL such as “data.fsisac.com” on which the data feeds are accessed.

Each user/client system may be separately required to access the data feed URL which would in turn submit a query to SharePoint to return the data. When opening up an API capability like this there is always a concern that the calling application could submit too many requests and effectively cause an un-intended denial of service attack. By default SharePoint does not have any kind of capabilities to limit the number of calls that the client application is making and so this would negatively impact the overall performance of the site. Also, if the client systems need to be able to download the entire collection of alerts this could put additional tax on the system. The following are few considerations that could address these points:

Data Feeds Server—Instead of hosting the data feed on SharePoint the data feed may be dumped from SharePoint onto another server as part of a nightly job. This secondary server would feed the data to the consuming application and therefore would only be as recent as the last data dump, but would not negatively impact the performance of the end users.

API Abuse Detection—An API lock out could detect the number of calls the client system is making and block any calls over a configurable threshold. This would ensure that the data feed URL remains responsive.

Full Data Dump & Differential—With the nightly data dump, it would be possible to do a full export of the alerts as well as configurable differential dumps. This would allow subscribing users the ability to choose what data they want to receive. Since only text based data is included in the dump (no attachments) and given the number of actual alerts, the actual dump file size would still be manageable. The dump file could be zipped for further compression.

VERIS Framework Classification

Implementing the taxonomy used as part of the VERIS framework is desirable.

There are overlaps with some of the metadata captured in the current implementation. A mapping of these overlaps may be performed along with data type compatibility. Some of the standard classification types and supporting lookup lists and values may be implemented. New VERIS compliant content types with relevant metadata could be created and associated with the alert list. The existing non-compliant content types could be marked as hidden, however the previously created content would remain intact. Additionally the edit and view pages for these new content types may be created.

Optionally if all of the exiting content is to be migrated into the VERIS format then some migration process may be setup. The same MetaLogix migration tool used for the migration from Archer may be used for this purpose. Value translations would be setup as part of the Migration configuration. For example, “ValueA” for column 1 now becomes “ValueB” in column 2.

CINS Profile Synchronization

FS-ISAC uses a service called “AlertFind” that is hosted by Dell/MessageOne for something referred to as “CINS” (Critical Infrastructure Notification System). All FS-ISAC members are registered with this service which is not used for portal notifications, but is used for other critical/disaster related scenarios. Currently members must maintain their contact information in CINS and will also have to maintain their information in their SharePoint profile. According to an embodiment of the present invention changes in SharePoint may be synchronized into the user's corresponding profile within CINS.

The CINS system does have an API that could be utilized to synchronize this data. As part of profile synchronization to Active Directory, however it is possible to also setup synchronization to other custom locations such as CINS. To do this a SharePoint .NET BCS connector may be created that would contain a mapping between the SharePoint profile fields and the fields available through CINS. The “username” could be used as the key to map the two together, but this would need to be confirmed by looking at the API.

Profile synchronization jobs depend on the type and amount of information being synchronized. Typically a BCS connector to the user profile database is pulling additional information into SharePoint as opposed to writing it back out. One way to integrate the connector to the CINS service would be that no field mapping are done, but that the code executes as part of the profile service synchronization timerjob. Another option is to create a custom timer job in which the synchronization to CINS happens independent of the AD profile sync.

The synchronization to CINS is one way, from SharePoint to CINS.

If a user updates their CINS profile, the values will be overwritten by SharePoint on the next update.

The “username” can be used as a key to access the record in CINS, and no other special “ID” field would need to be used.

The AlertFind product also accepts some kind of data dump in a XML or CSV format. It is possible to create a job that exports the key user profile information into this data dump format and then this file is sent to CINS. Send the file to CINS could be a manual process. It is possible this may be a more economical approach depending on how frequently the profile information changes.

1. A method for selectively permitting access over a computer network to two or more sets of information that have been assigned different confidentiality levels, comprising:
using a computer to designate a first set of information or collection of data with a first level of permitted access;
using a computer to designate a second set of information of collection of data with a second level of permitted access;
said first and second sets of information stored on a non-transitory computer-readable medium,
permitting access over a computer network to said first set of information via an authentication process that requires only a userID and a password;
permitting access over a computer network to said second set of information via an authentication process that requires only a userID, a password, and a hard token.

2. A method according to claim 1, comprising permitting access to said second set of information via an authentication process that requires only a hard token, provided that access has already been granted, in a same session, to said first set of information via a userID and a password.

3. A method according to claim 1, comprising permitting access to said first set of information via an authentication process that requires only a userID and password, then, in a same session, permitting access to said second set of information via a further authentication process that requires only a hard token.

4. A method according to claim 1, wherein said password serves as a PIN for said hard token.

5. A method according to claim 1, further comprising using a computer to designate a third set of information or collection of data with a third level of permitted access, said third said of information stored on a non-transitory computer-readable medium, and permitting access over a computer network to said third set of information without requiring an authentication process.

6. A method according to claim 5, comprising, in a single session, permitting access to said third set of information without requiring an authentication process, then, after permitting access to said third set of information, permitting access to said first set of information via an authentication process that requires only a userID and a password, then, after permitting access to said first set of information, permitting access to said second set of information via an authentication process that requires only a hard token.

7. A method for integrating an electronic message distribution list with an online discussion forum, comprising posting on said online discussion forum all messages sent to the distribution list.

8. A method according to claim 7, wherein posts on said online discussion forum of said messages sent to the distribution list, includes discussion threads associated with said messages.

9. A method according to claim 7, wherein access to said online discussion forum is permitted via an authentication process that requires only a userID and a password.

10. A method according to claim 7, wherein access to said online discussion forum is permitted via an authentication process that requires only a userID, a password, and a hard token.

11. A method according to claim 1, wherein said first set of information includes an online discussion forum.

12. A method according to claim 1, wherein said second set of information includes an online discussion forum.
